(19) United States
(12) Patent Application Publication
(10) Pub. No.: US 2026/0350008 A1
(43) Pub. Date: Nov. 5, 2026

(54) Systems and Methods for Validated Deployment and Runtime Application of Transformation Functions for Data Access Requests

(71) Applicant: Sandeep Shantharaj, Herndon, VA (US)

(72) Inventor: Sandeep Shantharaj, Herndon, VA (US)

(21) Appl. No.: 19/665,133

(22) Filed: May 1, 2026

Related U.S. Application Data
(60) Provisional application No. 63/798,770, filed on May 2, 2025.

(51) Int. Cl. G06F 16/2453

(52) U.S. Cl. CPC G06F 16/24549

(57) ABSTRACT

A transformation management system maintains approved transformation functions associated with query classes. Each approved transformation function has an approval state based on validation under a validation policy. At runtime, a runtime execution component receives a data access request, identifies that the request belongs to a query class, retrieves an approved transformation function from a transformation repository using a class identifier associated with the query class, and applies the approved transformation function to a request before execution and/or to a response received after execution. The runtime execution component may be external to a data platform or embedded in the data platform. Transformation functions may be obtained from automated generators or user interfaces, but are validated before runtime deployment, enabling bounded-latency transformation for query optimization, platform migration, and response normalization.

### CROSS-REFERENCE TO RELATED APPLICATION

This application claims the benefit of U.S. Provisional Patent Application No. 63/798,770, filed May 2 2025, entitled “System and Method for No-Code Scalable SQL Query Optimization Using AI-Generated Transformation Functions and Query Hashing,” the entire disclosure of which is incorporated herein by reference to the extent permitted.

### TECHNICAL FIELD

The disclosure relates generally to computerized data access systems, database systems, and query processing systems. More particularly, the disclosure relates to systems and methods for identifying classes of data access requests, validating transformation functions associated with such classes, deploying approved transformation functions, and applying the approved transformation functions at runtime to transform data access requests and/or responses.

### BACKGROUND

Modern data platforms process large volumes of data access requests, including Structured Query Language (SQL) queries submitted by applications, business intelligence tools, data pipelines, user interfaces, and autonomous software agents. Data access requests may be repeated many times with different literal values, parameters, users, schemas, target platforms, or execution contexts.

Certain systems have attempted query normalization, fingerprinting, execution-plan caching, or rewrite recommendation. However, such systems do not provide a robust end-to-end lifecycle in which reusable transformation functions are associated with query classes, validated under explicit correctness or compatibility policies, deployed to a runtime-accessible repository, and applied to matching runtime requests or responses without requiring a transformation function to be generated during each runtime request.

Manual optimization and manual migration of queries also do not scale well across enterprise workloads. A transformation that is correct for one query instance may be incorrect for another structurally similar query if literal handling, ordering semantics, schema differences, response metadata, platform-specific functions, or error behavior are not considered. Similarly, generating a rewritten query using an artificial intelligence system at runtime may introduce latency, uncertainty, and correctness risks.

Accordingly, there is a need for computer-implemented systems that separate relatively expensive or uncertain generation and validation of transformation functions from low-latency runtime application of already-approved transformation functions, while supporting different mechanisms for query-class identification and different deployment modes, including external middleware and embedded data-platform components.

### SUMMARY

In one embodiment, a transformation management system maintains an approved transformation function associated with a query class. The approved transformation function has an approval state based on validation under a validation policy and may be stored with validation evidence and approval metadata. A runtime execution component receives a data access request, determines that the request belongs to the query class, retrieves the approved transformation function using a class identifier associated with the query class, applies the approved transformation function to at least one of the request or a response associated with execution of the request, and causes execution of a transformed request and/or return of a transformed response.

In another embodiment, a candidate transformation function is obtained for a query class. The candidate transformation function may be generated by a large language model, another machine learning model, a rule engine, a database optimizer, or a user interface through which a platform user provides custom transformation logic. Regardless of source, the candidate transformation function is validated under a validation policy before being approved for runtime use.

In another embodiment, query classes are identified based on structural, syntactic, semantic, execution, or migration characteristics of data access requests. A class identifier may include or be derived from a normalized query template, a hash value, a canonical string, an abstract-syntax-tree signature, a logical-plan signature, an embedding-cluster identifier, a migration mapping identifier, a manually assigned identifier, or a composite identifier. These are non-limiting examples; the class identifier may be any value or representation that associates a runtime request with a query class.

In another embodiment, the runtime execution component is external to a target data platform, for example as a proxy, gateway, load balancer, sidecar, driver shim, or network service. In another embodiment, the runtime execution component is embedded in a data platform, for example as a pre-execution rewrite component, query compiler extension, optimizer-adjacent module, policy-enforcement component, response normalization module, or control-plane-managed runtime module.

The disclosed techniques may be applied to SQL query optimization, query migration, dialect translation, schema adaptation, response normalization, policy enforcement, data masking, error-code mapping, and other transformations that benefit from validated deployment and bounded-latency runtime application. The examples in this disclosure are illustrative and do not limit the scope of the claimed invention except as expressly recited in the claims.

### BRIEF DESCRIPTION OF THE DRAWINGS

FIG. 1 illustrates an example system architecture including a transformation management system, a transformation repository, a validation module, and a runtime execution component.

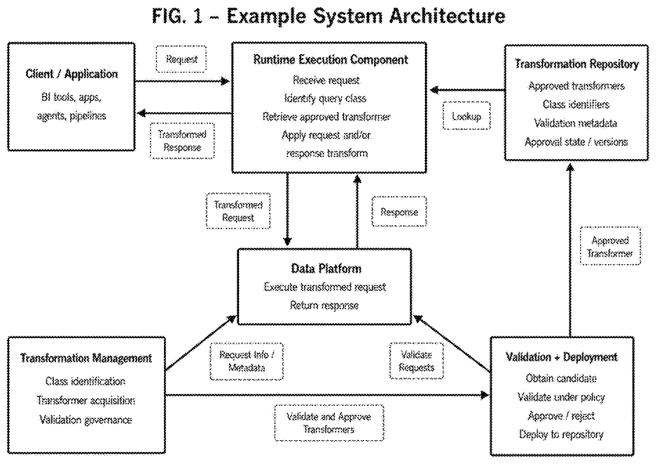

FIG. 2 illustrates an example lifecycle for obtaining, validating, approving, deploying, and applying a transformation function associated with a query class.

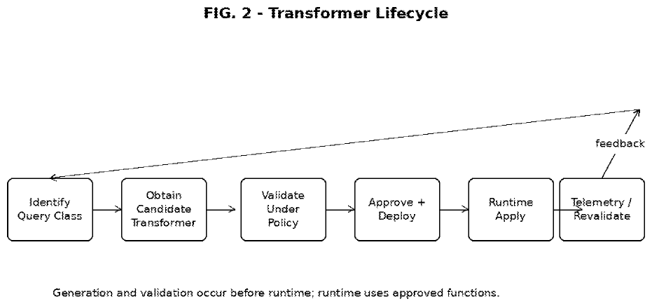

FIG. 3 illustrates an example query-class identification process using normalization, class identifiers, and optional hashing.

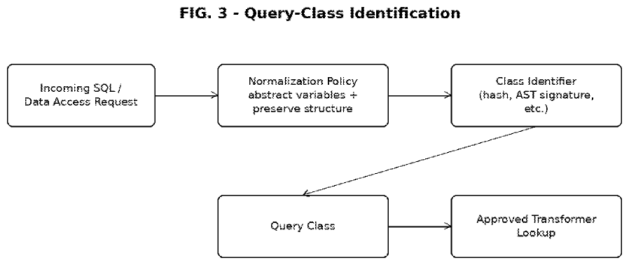

FIG. 4 illustrates an example validation workflow for request transformations and response transformations.

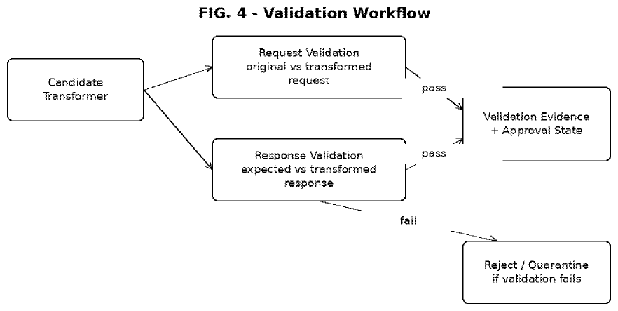

FIG. 5 illustrates example external and embedded deployment modes for a runtime execution component.

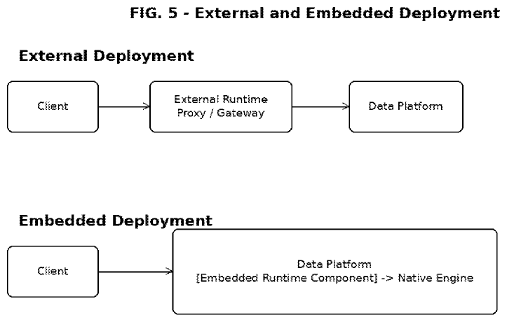

FIG. 6 illustrates an example transformation repository data structure storing approved transformation functions, validation evidence, approval state, versioning metadata, and rollback metadata.

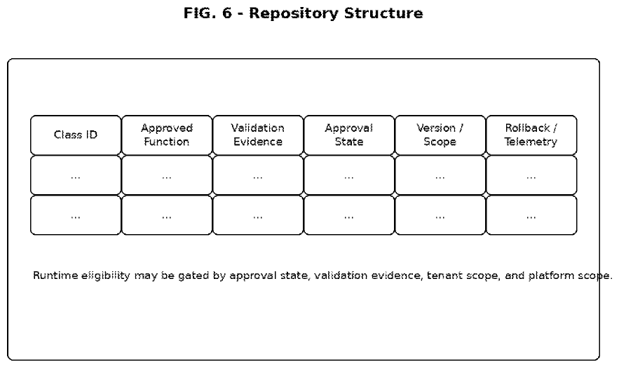

### DETAILED DESCRIPTION

### 1. Overview

The disclosed system addresses a technical problem in computerized data access: how to safely apply reusable query or response transformations at scale without performing expensive or uncertain generation and validation during each runtime request. The system separates transformation-function generation and validation from runtime application. In a pre-runtime or administrative phase, a transformation function is obtained for a query class, validated under a validation policy, approved, and deployed to a repository accessible by a runtime execution component. During runtime, the runtime execution component identifies the query class of a data access request, retrieves an approved transformation function for that class, and applies the transformation function with bounded latency.

A technical advantage of this separation is that runtime transformation can be performed using a previously approved transformation function and associated validation state, rather than generating or validating a new transformation function in the request path. In certain embodiments, the runtime execution component applies deterministic or bounded transformation logic and uses repository metadata to determine whether the transformation function remains eligible for runtime application.

Although many embodiments are described using SQL queries, the techniques may be applied to other structured data access requests having classifiable syntax, semantics, execution behavior, or response formats. SQL is a principal embodiment and provides a concrete implementation context.

### 2. Definitions

As used herein, a “data access request” includes a request to retrieve, modify, aggregate, transform, or otherwise access data. Examples include SQL queries, parameterized SQL statements, stored procedure calls, platform-specific query-language requests, graph queries, and structured API requests. In primary embodiments, the data access request is a SQL query.

A “query class” refers to a grouping, category, or class of data access requests determined based on one or more characteristics, including structural characteristics, syntactic characteristics, semantic characteristics, execution characteristics, source-platform characteristics, target-platform characteristics, schema-mapping characteristics, or migration characteristics. A query class may group requests that differ in literal values but share a structural form. A query class may also group requests that share a migration pattern, response-shape pattern, or policy-transformation pattern.

A “class identifier” refers to an identifier associated with a query class. A class identifier may be or include a hash, but need not be limited to a hash. Non-limiting examples include a hash of a normalized request, a canonical template, a normalized string, an AST signature, a logical-plan signature, an embedding-cluster identifier, a migration mapping identifier, a manually assigned identifier, or a composite identifier.

A “normalization policy” refers to a set of rules, configuration parameters, heuristics, or model outputs identifying elements of a data access request that should be preserved, replaced, abstracted, reordered, or ignored for purposes of query-class identification.

A “transformation function” refers to executable, interpretable, or declarative logic that transforms at least one of a data access request, a representation of a data access request, a response from a data platform, response metadata, error information, or a combination thereof. Non-limiting examples include regular-expression rules, templates, AST rewrite rules, logical-plan rewrite rules, schema-mapping rules, response-normalization rules, executable scripts, compiled functions, plugins, or other deterministic or bounded logic.

An “approved transformation function” refers to a transformation function that has satisfied a validation policy, has an approval state authorizing runtime application, and is associated with at least one query class or class identifier.

A “validation policy” refers to machine-readable or administratively configurable criteria used to determine whether a candidate transformation function may be approved. Validation policies may test correctness, compatibility, schema conformance, response conformance, error behavior, performance characteristics, security requirements, or combinations thereof.

### 3. Transformation Management System

In one embodiment, a transformation management system includes a class-identification module, a transformer acquisition module, a validation module, a deployment controller, a transformation repository, and a runtime execution component. These components may execute on one or more processors and may be distributed across services, nodes, tenants, or platforms.

The class-identification module receives or accesses a data access request and determines a query class. In SQL embodiments, the class-identification module may normalize the SQL query according to a normalization policy. The normalization policy may designate elements whose replacement or abstraction does not change membership in the query class, while preserving structural elements that are used to identify the query class. Such replaceable or abstractable elements may include, by way of non-limiting example, literal values, parameter values, pagination values, tenant-specific identifiers, environment-specific identifiers, comments, hints, aliases, time-window values, session variables, schema-specific tokens, platform-specific syntactic decorations, or other variable elements.

The transformer acquisition module obtains candidate transformation functions. A candidate transformation function may be generated by one or more large language models, other machine learning models, rule engines, database optimizers, migration tools, or a user interface. A platform user may author or edit a custom transformation function, but the custom transformation function may still be subject to the same validation, approval, deployment, versioning, and rollback lifecycle as an AI-generated transformation function.

The validation module evaluates candidate transformation functions against one or more validation policies. The deployment controller marks transformation functions as approved, rejected, quarantined, superseded, or pending review. Approved transformation functions may be stored in the transformation repository together with class identifiers, version identifiers, validation evidence, approval metadata, approval source, tenant scope, target-platform scope, source-platform scope, deployment status, rollback metadata, and telemetry requirements.

### 4. Query-Class Identification

A query class may be identified using one or more techniques. In a normalization-based embodiment, literal values and other non-structural tokens are replaced with placeholders to create a normalized representation. A hash value may then be generated from the normalized representation. Hashing is one example of assigning or deriving a class identifier, but the invention is not limited to hashing.

In an AST-based embodiment, the request is parsed into an abstract syntax tree and the tree, or selected features of the tree, are used to derive a class identifier. In a logical-plan embodiment, an optimizer or parser produces a logical plan, and selected logical-plan operators or relationships are used to derive a class identifier. In a manually assigned embodiment, a platform user or administrator associates a query class with a class identifier. In a migration embodiment, a class identifier may represent a source-platform-to-target-platform mapping, a schema remapping, or a dialect-conversion pattern.

In an embedding-based embodiment, a representation of the request, such as a normalized request string, AST summary, logical-plan summary, schema context, or platform context, is embedded into a vector representation. Requests whose vector representations fall within a cluster or similarity threshold may be tentatively associated with a query class. To reduce false positives, transformation functions associated with embedding-derived query classes may be approved only after validation against representative requests assigned to the cluster, and runtime assignment may be constrained by structural checks, schema checks, or confidence thresholds.

### 5. Transformation Function Sources and Forms

A candidate transformation function may be obtained from multiple sources. In one embodiment, an automated generator, such as a large language model, other artificial-intelligence model, machine-learning model, rule engine, database optimizer, migration engine, template generator, or program-synthesis engine, receives an original query, an optimized or target query, a normalized representation, schema information, platform context, and constraints specifying permitted transformations. The automated generator outputs a candidate transformation function and optionally test cases. In another embodiment, a user authors a transformation function through a user interface. In another embodiment, a conventional optimizer, rule engine, or migration engine proposes a transformation function. Regardless of source, the candidate transformation function is not deployed for runtime application unless it satisfies a validation policy.

Transformation functions may take different forms. A regular-expression transformation function may match and rewrite query text while preserving captured groups. A template transformation function may emit a target query form using bound variables. An AST rewrite may modify parsed query nodes and regenerate query text. A schema-mapping transformation may map table names, column names, types, or response metadata. A response-normalization transformation may modify rows, column labels, types, error codes, pagination metadata, or other response fields.

### 6. Validation of Request Transformations

For request transformations, validation may include executing an original request and a transformed request against the same database snapshot, sandbox environment, staging environment, or controlled data subset. The validation module may compare correctness characteristics such as result sets, schemas, row counts, sorted or unordered row representations, checksums, aggregates, error behavior, null-handling behavior, time-zone behavior, pagination behavior, or statistical properties. The validation module may also optionally compare execution characteristics, including latency, compute usage, scanned data, or execution-plan attributes.

A validation policy may specify that row ordering is ignored when the original request lacks an ORDER BY clause, that floating-point values are compared within a tolerance, that selected volatile fields are excluded, that a specific transaction isolation level or snapshot must be used, or that a minimum number of test cases must pass. Test cases may be generated by an AI model, generated programmatically, derived from observed production requests, or supplied by a user.

### 7. Validation of Response Transformations

For response transformations, validation may include comparing an original response format expected by a client with a transformed response generated from a target platform response. The validation module may validate response schema, column names, column order, type conversions, numeric precision, timestamp representation, error-code mapping, pagination metadata, null semantics, and compatibility with client expectations.

For example, a source platform may return uppercase column labels and timestamp values as formatted strings, while a target platform may return lowercase column labels and native timestamp objects. A response transformation function may normalize the target-platform response into the source-platform response format. The validation module may compare the transformed response to an expected response schema and may execute representative requests to verify client-compatible behavior.

### 8. Deployment and Runtime Application

Once a candidate transformation function is approved, the deployment controller stores the approved transformation function in a transformation repository. The repository may be a database, distributed cache, metadata service, configuration service, object store, key-value store, or other runtime-accessible storage. The approved transformation function may be indexed by a class identifier and may be stored with validation evidence, approval state, versioning metadata, tenant scope, platform scope, rollback metadata, and telemetry policy. At least a portion of the validation evidence, approval state, and scope metadata may be used by the runtime execution component or deployment controller to determine whether the approved transformation function is eligible for runtime application.

At runtime, the runtime execution component receives or intercepts a data access request, identifies its query class, retrieves one or more approved transformation functions associated with that class, and applies the retrieved function or functions to at least one of the request or a response associated with execution of the request. Runtime application may occur without invoking an AI model to generate a transformation function during processing of the runtime request. This separation of validation and deployment from runtime application supports bounded-latency execution and reduces correctness risks.

Response transformation selection may be tied to the request context. In embodiments involving response transformation, the runtime execution component may associate a response received from a data platform with an originating request context, including a query class, class identifier, request identifier, session identifier, transaction identifier, source-platform identifier, target-platform identifier, or transformation-plan identifier. The runtime execution component may select a response transformation function based on the class identifier, response-shape metadata, source-platform context, target-platform context, or client compatibility requirements. A response transformation function may be applied even when the originating request is not transformed, provided that the response transformation function is approved for the applicable query class or response-shape class.

If multiple approved transformation functions are associated with a query class, the runtime execution component may apply them according to a transformation plan. The transformation plan may specify order, conditions, compatibility requirements, dependency metadata, priority, fallback behavior, and whether the plan as a whole has been validated. For example, a first transformation may translate dialect syntax, a second may remap schema identifiers, and a third may normalize a response. A composed transformation plan may be validated as a whole, and incompatible transformations may be rejected, quarantined, or reordered.

### 9. External and Embedded Runtime Components

In an external deployment, the runtime execution component may be any component external to a data platform and configured to receive a runtime data access request before the runtime data access request is received by the data platform. Non-limiting examples include a proxy, gateway, load balancer, sidecar, driver shim, network service, application-layer middleware, or query-routing service. The external component may receive SQL queries from business intelligence tools, applications, agents, or data pipelines and may forward transformed requests to a target platform.

In an embedded deployment, the runtime execution component may be part of a data platform or database system. For example, a cloud data platform may include a pre-execution rewrite module that identifies a query class before query compilation or before physical planning, retrieves an approved transformation function and validation metadata from a transformation repository, applies the approved transformation function, and then passes the transformed request to a native parser, compiler, optimizer, or execution engine. In another embedded embodiment, a post-execution response module transforms response metadata or result rows before returning them to a caller.

The embedded runtime component is distinct from a conventional cost-based optimizer in that it applies an approved transformation function associated with a query class and having validation metadata, rather than merely producing a native execution plan for the original request.

### 10. Concrete SQL Transformation Example

In one SQL embodiment, requests of a query class have the form:

SELECT*FROM orders WHERE customer_id=<literal>ORDER BY created_at DESC LIMIT<literal>

A class-identification module replaces literal values with placeholders and determines a class identifier for the normalized template:

SELECT*FROM orders WHERE customer_id=?ORDER BY created_at DESC LIMIT?

A candidate transformation function may rewrite the projection to include only columns needed by a consuming application:

SELECT order_id, customer_id, created_at, status FROM orders WHERE customer_id=?ORDER BY created_at DESC LIMIT?

The validation module may execute representative requests using different customer_id and LIMIT values and compare result schemas, row counts, ordering, and selected column values. If the consuming application does not require omitted columns, a validation policy may approve the projection reduction for that query class and tenant context. The approved transformation function and validation evidence may then be stored in the repository for runtime use.

In another SQL embodiment, a transformation function may rewrite a correlated subquery into a join or may push a selective predicate into a subquery before aggregation. For example, an original request may compute an aggregate over a broad subquery and then filter by customer or date range outside the subquery. A validated transformation function associated with the query class may move the filter into the subquery where permitted by the validation policy, thereby reducing scanned data while preserving the result under the validation policy. Representative test cases may verify null handling, duplicate-row behavior, aggregate equivalence, and ordering requirements before the transformation is approved for runtime use.

### 11. Concrete Cross-platform Request/response Example

In a migration embodiment, a source platform supports a pagination syntax or function syntax different from a target platform. For example, a source SQL request may include:

SELECT TOP 100 customer_id, order_date FROM orders WHERE COALESCE(status, ‘OPEN’)=‘OPEN’

A target platform may require a different pagination syntax, identifier convention, or null-handling expression. A request transformation function may rewrite the request into a target-platform-compatible form, such as:

SELECT customer_id, order_date FROM orders WHERE COALESCE(status, ‘OPEN’)=‘OPEN’LIMIT 100

A response transformation function may then normalize the target-platform response into a source-compatible response format. For example, if the source platform returns column names in uppercase and the target platform returns lowercase column names, the response transformation function may map response metadata to the expected column-name format. If the source platform returns specific error codes, the response transformation function may map target-platform error codes to source-compatible error codes. Validation may verify both request-level semantic equivalence and response-level compatibility.

As a further example, a source-platform query using a QUALIFY clause or a platform-specific window-function filtering construct may be transformed into a target-platform query using a nested subquery that computes the window function and applies the filter in an outer SELECT. Validation may compare result sets for representative partitions, ordering conditions, null values, and tie-breaking cases. A corresponding response transformation may normalize column labels, type metadata, warnings, and error codes so that a client expecting source-platform behavior can operate against the target platform without application-code changes.

### 12. Failure Handling, Rollback, and Feedback

The runtime execution component may implement fail-open behavior. If no approved transformation function exists for a query class, the original request may be forwarded unchanged. If application of a transformation function fails, if transformed execution returns an unexpected error, if telemetry indicates validation drift, or if schema changes invalidate prior validation, the system may quarantine or revoke the transformation function, roll back to a prior version, retry using the original request, or notify an administrator.

Telemetry may include execution latency, compute cost, error rate, result discrepancies, schema changes, response-shape changes, or user feedback. Telemetry may trigger revalidation, approval-status changes, generation of new candidate transformation functions, or update of an existing transformation function.

1. A computer-implemented method performed by one or more processors of a transformation management system, the method comprising:
maintaining, in a transformation repository, an approved transformation function associated with a query class, wherein the approved transformation function has an approval state based on validation of the approved transformation function under a validation policy;
receiving, by a runtime execution component, a runtime data access request;
identifying, by the runtime execution component, that the runtime data access request belongs to the query class;
retrieving, from the transformation repository using a class identifier associated with the query class, the approved transformation function;
applying the approved transformation function to at least one of: (i) the runtime data access request before execution by a data platform to generate a transformed data access request; or (ii) a response received from the data platform after execution of the runtime data access request or the transformed data access request to generate a transformed response; and
causing execution of the transformed data access request or causing return of the transformed response.

2. The method of claim 1, wherein the runtime data access request comprises a SQL query, and wherein identifying that the runtime data access request belongs to the query class comprises generating a normalized representation of the SQL query according to a normalization policy that replaces or abstracts one or more elements designated by the normalization policy as not changing membership in the query class while preserving one or more structural components used to identify the query class.

3. The method of claim 1, wherein the class identifier is derived from a representation of the runtime data access request or an expected response associated with the runtime data access request, the representation comprising at least one of a syntactic representation, structural representation, semantic representation, execution-plan representation, migration-mapping representation, response-shape representation, administratively assigned class representation, or composite representation.

4. The method of claim 3, wherein the class identifier comprises a hash generated from a normalized SQL representation that preserves at least one structural component of the SQL query while abstracting one or more literals, parameters, or variable elements.

5. The method of claim 1, further comprising obtaining a candidate transformation function from at least one of an automated generator or a user interface, wherein the automated generator comprises at least one of a large language model, artificial-intelligence model, machine-learning model, rule engine, optimizer, migration engine, template generator, or program-synthesis engine, wherein the candidate transformation function is represented as at least one of a declarative rule, template, parse-tree rewrite, logical-plan rewrite, mapping definition, executable routine, plugin, or compiled function, and wherein the candidate transformation function is not approved for runtime application unless the candidate transformation function satisfies the validation policy.

6. The method of claim 5, further comprising validating a request transformation performed by the candidate transformation function by executing an original data access request and a transformed data access request and comparing correctness characteristics comprising at least one of result sets, schemas, row counts, checksums, error behavior, null-handling behavior, ordering behavior, pagination behavior, or statistical properties, and optionally comparing execution characteristics.

7. The method of claim 5, further comprising validating a response transformation performed by the candidate transformation function by comparing a transformed response to at least one of an expected response schema, expected column naming convention, expected type representation, expected error model, expected metadata format, expected client-compatible response format, or expected source-platform-compatible response format.

8. The method of claim 5, further comprising storing, in association with the approved transformation function, validation evidence comprising at least one of a validation-policy identifier, test-case identifier, validation result, snapshot identifier, tolerance rule, excluded-field rule, approval source, version identifier, tenant scope, source-platform scope, or target-platform scope, wherein at least a portion of the validation evidence is used to determine whether the approved transformation function is eligible for runtime application.

9. The method of claim 1, wherein the transformation repository stores the approved transformation function together with approval state and validation metadata indexed by the class identifier.

10. The method of claim 1, wherein applying the approved transformation function during processing of the runtime data access request occurs without invoking an artificial-intelligence model to generate the approved transformation function during the processing of the runtime data access request.

11. The method of claim 1, wherein retrieving the approved transformation function comprises retrieving a plurality of approved transformation functions associated with the query class, and wherein applying the approved transformation function comprises applying the plurality of approved transformation functions sequentially, conditionally, or according to a validated transformation plan.

12. The method of claim 1, wherein the approved transformation function modifies, according to a transformation policy validated for the query class, at least one of syntax, structure, platform compatibility, execution behavior, semantic representation, platform-specific semantic behavior, response format, response metadata, or error behavior of at least one of the runtime data access request or the response received from the data platform.

13. The method of claim 1, wherein the runtime execution component is external to the data platform and is configured to receive the runtime data access request before the runtime data access request is received by the data platform.

14. The method of claim 1, wherein the runtime execution component is embedded within the data platform and is configured to retrieve the approved transformation function and the validation metadata from the transformation repository before a native execution engine of the data platform executes the transformed data access request or before a transformed response is returned to the caller.

15. The method of claim 1, further comprising, in response to at least one of a runtime failure, validation drift, schema change, policy violation, or unexpected error associated with the approved transformation function, automatically updating the approval state of the approved transformation function and performing at least one of quarantining the approved transformation function, rolling back to a prior version, executing an untransformed request, retrying with an alternate approved transformation function, or issuing a notification.

16. A system comprising one or more processors and one or more memories storing instructions that, when executed by the one or more processors, cause the system to implement:
a class-identification module configured to determine a query class for a data access request and to generate a class identifier associated with the query class;
a validation module configured to validate candidate transformation functions under validation policies;
a deployment controller configured to approve candidate transformation functions that satisfy the validation policies and to deploy approved transformation functions;
a transformation repository configured to store the approved transformation functions indexed by class identifiers and to store validation metadata and approval state associated with the approved transformation functions; and
a runtime execution component configured to retrieve an approved transformation function from the transformation repository using a class identifier generated for a runtime data access request and to apply the approved transformation function to at least one of the runtime data access request or a response associated with execution of the runtime data access request.

17. The system of claim 16, wherein the runtime execution component is configured to perform both request transformation and response transformation for cross-platform migration between a source data platform and a target data platform.

18. The system of claim 16, wherein the transformation repository stores versioning metadata, tenant-scope metadata, platform-scope metadata, approval state, validation evidence, and rollback metadata for the approved transformation functions.

19. A non-transitory computer-readable medium storing instructions that, when executed by one or more processors, cause the one or more processors to:
maintain an approved transformation function associated with a query class in a transformation repository, the approved transformation function having an approval state based on validation under a validation policy;
receive a runtime data access request;
identify that the runtime data access request belongs to the query class;
retrieve the approved transformation function from the transformation repository using a class identifier associated with the query class;
apply the approved transformation function to at least one of: (i) the runtime data access request before execution by a data platform to generate a transformed data access request; or (ii) a response received from the data platform after execution of the runtime data access request or the transformed data access request to generate a transformed response; and
cause execution of the transformed data access request or return of the transformed response.

20. The method of claim 1, further comprising collecting telemetry associated with runtime application of the approved transformation function and, based on the telemetry, triggering at least one of revalidation of the approved transformation function, revocation of the approval state, quarantine of the approved transformation function, generation of a new candidate transformation function, or update of a transformation plan.
